(19) United States
(12) Patent Application Publication
(10) Pub. No.: US 2026/0002575 A1
(43) Pub. Date: Jan. 1, 2026

(54) DAMPER HAVING BYPASS, METHOD FOR PRODUCING THE DAMPER

(71) Applicant: Stabilus GmbH, Koblenz (DE)

(72) Inventors: Lars Löhken, Linz am Rhein (DE); Ulrich Probst, Hillscheid (DE); Till Stumpf, Nordhofen (DE)

(21) Appl. No.: 19/248,727

(22) Filed: Jun. 25, 2025

(30) Foreign Application Priority Data
Jul. 1, 2024 (DE) 102024118559.7

(51) Int. Cl. F16F 9/346; F16F 9/34

(52) U.S. Cl. CPC F16F 9/346; F16F 9/3405; F16F 2222/12; F16F 2224/025; F16F 2226/04; F16F 2230/30

(57) ABSTRACT

The invention relates to a damper (100) comprising a pressure tube (110) filled with a damping fluid; a piston (120) displaceably mounted in the pressure tube (110) along a stroke axis (H), wherein the piston (120) divides the pressure tube (110) into a front chamber (111) along the stroke axis (H) in front of the piston (120) and a rear chamber (112) along the stroke axis (H) behind the piston (120); a piston rod (130) fastened to the piston (120), wherein the piston rod (130) is led out of the pressure tube (110) through the rear chamber (112) along the stroke axis (H); and a bypass (140) arranged outside the pressure tube (110), wherein the bypass (140) connects the front chamber (111) to the rear chamber (112) in a manner that conducts the damping fluid. The bypass (140) is delimited at least in portions by a bypass wall (141), wherein the bypass wall (141) is elastically deformable into the bypass (140) to accommodate a volume of the damping fluid displaced by the piston rod (130) when the piston rod (130) is inserted into the pressure tube (110).

### RELATED APPLICATIONS

This U.S. patent application claims priority to German Patent Application No. 102024118559.7, filed on Jul. 1, 2024, which is hereby incorporated by reference in its entirety.

### TECHNICAL FIELD

The invention relates to a damper comprising a pressure tube filled with a damping fluid; a piston displaceably mounted in the pressure tube along a stroke axis, wherein the piston divides the pressure tube into a front chamber along the stroke axis in front of the piston and a rear chamber along the stroke axis behind the piston; a piston rod fastened to the piston, wherein the piston rod is led out of the pressure tube through the rear chamber along the stroke axis; and a bypass arranged outside the pressure tube, wherein the bypass connects the front chamber to the rear chamber in a manner that conducts the damping fluid.

The invention also relates to a method for producing the damper.

### PRIOR ART

Publication US 2019/106849 A1 discloses a hydraulic damper whose pressure tube is designed as a double tube. Between the walls of the double tube, hydraulic oil can flow from a front chamber of the pressure tube in front of the piston of the damper into a rear chamber of the pressure tube behind the piston. In order for the piston rod of the damper, which is led out of the damper through the rear chamber, to be able to move into the pressure tube, the pressure tube or the space between the walls must contain a compressible gas in addition to the hydraulic oil. However, the gas must not accumulate in the front chamber or foam the hydraulic oil, as this would impair the damping effect of the damper. Consequently, the damper must be kept in alignment with the rear chamber above the front chamber and must not be subjected to excessive movement or vibration. Excessively rapid movements of the piston in the damper must also be avoided because they could lead to foaming. Therefore, the possible applications of the damper from US 2019/106849 A1 are limited.

The hydraulic damper described in publication DE 33 21 680 A1 also comprises a pressure tube designed as a double tube. Here, the intermediate space between the walls of the pressure tube serves only as a compensation space that contains the compressible gas and a portion of the hydraulic oil. This reduces the risk of foaming, but the damper still needs to be kept in a certain orientation to prevent gas from entering the front chamber. In addition, according to DE 33 21 680 A1, the piston of the damper must have a bypass so that the hydraulic oil can flow from the front chamber to the rear chamber. This requires a piston having a complex construction.

Publications DE 42 12 078 A1 and DE 22 45 258 A1 disclose a hydraulic damper comprising a compensation space arranged on an outer side of the pressure tube of the damper, which compensation space is delimited by an elastic sleeve. This means that the damper can be completely filled with hydraulic oil in accordance with DE 42 12 078 A1 and DE 22 45 258 A1, so that the problems caused by additional gas do not occur. However, these dampers also require a bypass inside their pressure tube so that the hydraulic oil can flow from the front to the rear chamber, which complicates the production of the damper. In addition, a bypass inside the pressure tube makes it difficult to block the damper at high piston rod insertion speeds. Such blocking is necessary, for example, for using the damper as a damper of a speed bump in accordance with US 2019/106849 A1 or in accordance with publication DE 10 2020 109 215 A1.

### Technical Object

The object of the invention is to provide a simply constructed damper that can be used in a variety of ways, in particular independently of an orientation of the damper and/or for a wide range of movement speeds of the piston in the pressure tube of the damper.

### Technical Solution

The present invention provides a damper according to claim 1, which achieves the technical object. The object is also achieved by a method for producing the damper according to claim 18. Advantageous designs are the subject matter of the dependent claims.

The damper comprises at least one pressure tube filled with a damping fluid. The damping fluid is, for example, a hydraulic oil. The pressure tube is, for example, hollow-cylindrical and/or made of a metal, in particular steel.

The damper comprises at least one piston that is mounted in the pressure tube so as to be displaceable along a stroke axis. The piston is, for example, cylindrical and/or made of a metal, in particular steel. The stroke axis is, for example, coaxial with the piston and/or with the pressure tube.

The piston divides the pressure tube into at least one front chamber along the stroke axis in front of the piston and at least one rear chamber along the stroke axis behind the piston. Preferably, the piston separates the front chamber from the rear chamber to form a fluid-tight seal against the damping fluid. The piston preferably carries at least one sealing element that seals the piston to an inner side of a jacket wall of the piston that runs about the stroke axis.

The damper comprises at least one piston rod fastened to the piston, wherein the piston rod is led out of the pressure tube through the rear chamber along the stroke axis, for example coaxially with the stroke axis. The piston rod is preferably guided out of the pressure tube by at least one guide and seal unit, wherein the guide and seal unit guides the piston rod along the stroke axis and closes the pressure tube to form a fluid-tight seal against the damping fluid.

The damper comprises at least one bypass arranged outside the pressure tube, wherein the bypass connects the front chamber to the rear chamber in a manner that conducts the damping fluid. The bypass advantageously allows the damping fluid displaced by the piston to flow from the front chamber into the rear chamber or from the rear chamber into the front chamber, depending on a direction of movement of the piston.

The bypass thus allows the piston to be displaced along the stroke axis.

The bypass is delimited at least in portions by a bypass wall, wherein the bypass wall is elastically deformable into the bypass to accommodate a volume of the damping fluid displaced by the piston rod when the piston rod is inserted into the pressure tube.

The bypass is preferably delimited in portions by a jacket wall of the pressure tube running about the stroke axis. By using the jacket wall to delimit the bypass, additional material for delimiting the bypass is saved.

### Beneficial Effects

Due to the elastic deformability of the bypass wall, the bypass can absorb the volume of damping fluid displaced when the piston rod is inserted into the pressure tube, so that the piston rod can be inserted without the damper having to contain a compressible gas or other measures for volume compensation. The pressure tube and the bypass can thus be completely filled with the damping fluid, so that there is no risk of gas accumulating in the front chamber or the damping fluid foaming. The damper is therefore particularly versatile, in particular independent of its orientation, and can be used for a wide speed range of a movement to be damped with the damper.

The bypass wall can be placed directly or indirectly against the jacket wall of the pressure tube over almost its entire length and forms an outer wall of the damper.

Because the bypass provides both the function of volume compensation and the function of connecting the front chamber to the rear chamber, no additional components are required for these functions, so that the damper, in particular the piston of the damper, can be constructed particularly simply.

The advantages mentioned are particularly important when the damper is used as a damper of a speed bump in accordance with US 2019/106849 A1 or in accordance with publication DE 10 2020 109 215 A1. In this use, gas in the damper is particularly problematic because, depending on the speed of vehicles driving over the speed bump, movements of the speed bump must be damped over a wide speed range. Furthermore, due to the installation location of the damper under the speed bump, it is particularly difficult to remove gas that has collected in the front chamber by completely inserting the piston rod.

### DESCRIPTION OF THE TYPES OF EMBODIMENTS

The bypass wall is preferably formed by at least one hose. The bypass wall is particularly easy to implement as a hose.

The pressure tube is preferably arranged in the hose so that the bypass runs between the jacket wall and the hose. For example, the pressure tube is located coaxially in the hose. In this way, the bypass can be created particularly simply and with minimal use of materials, for example by pulling the hose over the pressure tube and sealingly fastening it at the ends of the hose to the jacket wall. To allow the damping fluid to flow from the front chamber and from the rear chamber into the bypass, the pressure tube can have a number of openings through the jacket wall.

By arranging the pressure tube in the hose, the hose, which forms the outer wall, can advantageously protect the pressure tube, for example from mechanical and/or chemical stresses, in particular in a corrosive environment. A corrosive environment can be caused, for example, by road salt and condensation water when the damper is used under a speed bump or in the chassis of a vehicle. In order to protect parts of the damper not covered by the hose from corrosion, the damper is provided with an anti-corrosive coating in a dipping process, for example after the hose has been attached to the pressure tube.

The damper preferably comprises spacing means for spacing the bypass wall from the jacket wall. In other words, the damper comprises a spacer.

Due to the elasticity of the bypass wall, the bypass wall can lie against the jacket wall, in particular when the piston rod is in a position extended far out of the pressure tube, so that only a small amount of damping fluid is in the bypass. This can block the bypass so that the damping fluid cannot flow from the front chamber to the rear chamber and back, so that the piston is blocked in the pressure tube or a negative pressure is created behind the piston, which can lead to air from outside flowing into the pressure tube. These problems are solved by the spacing means. In addition to or as an alternative to the spacing means, the damping fluid can be filled into the pressure tube and the bypass at a sufficiently high pressure to prevent the bypass wall from lying against the jacket wall.

The spacing means preferably comprise at least one sleeve, for example a hollow-cylindrical sleeve, arranged between the bypass wall and the jacket wall and having a number of channels for the connection of the front chamber to the rear chamber in a manner that conducts the damping fluid. The channels are formed, for example, by grooves in a surface, in particular in an inner surface, of the sleeve. The sleeve preferably comprises a number of breaches, for example bores and/or punchings, for the passage of the damping fluid, in particular radially to the stroke axis, through the sleeve. The breaches advantageously allow the damping fluid to pass from a region between the sleeve and the jacket wall, in particular from the grooves, into a region between the sleeve and the bypass wall, so that the region between the sleeve and the bypass wall can serve as a compensation space for accommodating damping fluid displaced from the pressure tube. The sleeve can advantageously be designed independently of requirements that exist for the jacket wall and/or the bypass wall.

For example, a sleeve material can be chosen that it is particularly elastic, lightweight, cost-effective and/or easy to process. The sleeve is preferably made of an elastomer, preferably a thermoplastic elastomer, particularly preferably a urethane-based thermoplastic elastomer.

An elastic sleeve can advantageously adapt to the volume of damping fluid in the bypass and thereby increase the flow through the bypass. If the spacing means are formed by the sleeve, the jacket wall and the bypass wall can be formed by standard components to minimize the cost of producing the damper.

An alternative embodiment provides that the spacing means preferably comprise at least one structuring of a surface of the bypass wall, which surface faces the jacket wall for spacing the bypass wall from the jacket wall. The bypass wall having the structuring is, for example, manufactured additively, in particular by 3D printing. Because the spacing means are designed as a structuring of the bypass wall, no separate component is required, making the damper particularly simple to assemble. However, the structuring of the bypass wall can also be provided in addition to the aforementioned sleeve.

The structuring of the surface of the bypass wall facing the jacket wall preferably comprises a number of knobs and/or a number of grooves for the connection of the front chamber to the rear chamber in a manner that conducts the damping fluid. A shape, a size and/or a distance of the knobs from each other is preferably selected so that the bypass wall cannot lie against the bypass and the jacket wall.

The number of grooves of the sleeve and/or the bypass wall preferably comprises a number of circumferential grooves running about the stroke axis, and the number of grooves preferably comprises a number of axial grooves running along the stroke axis, which are connected to the circumferential grooves in a manner that conducts the damping fluid. This allows the circumferential grooves to distribute damping fluid exiting the pressure tube through the openings to the axial grooves, so that all of the axial grooves contribute to conducting the damping fluid from the front chamber to the rear chamber and back.

The damper preferably comprises a number of openings for the connection of the front chamber and the rear chamber to the bypass in a manner that conducts the damping fluid.

The openings are preferably formed in the jacket wall. For example, the openings can be simply designed as bores and/or punchings.

Alternatively, it is conceivable to provide the openings of the two chambers to the bypass in connecting components, wherein a sealing of the connecting components with respect to the pressure tube and the bypass wall must be ensured.

It is also conceivable to close the pressure tube with the bypass wall or the sleeve and to arrange the openings in a cup-shaped region of the bypass wall or the sleeve, which cup-shaped region is provided for the frontal closure of the pressure tube.

The openings are preferably connected to the circumferential grooves in a manner that conducts the damping fluid.

The bypass wall and/or the sleeve preferably comprises at least one sealing surface, wherein the sealing surface is fastened to, preferably clamped, glued, welded and/or vulcanized onto, the jacket wall to form a fluid-tight seal against the damping fluid. The sealing surface is clamped onto the jacket wall, for example, by a hose clamp or a protective tube that presses the bypass wall and/or the sleeve against the jacket wall. The sealing surface preferably has no structuring, channels or breaches. The, in particular unstructured, sealing surface, advantageously prevents the damping fluid from escaping from the bypass between the bypass wall and/or the sleeve and the jacket wall.

The bypass wall is preferably made of an elastomer, preferably a thermoplastic elastomer, particularly preferably a urethane-based thermoplastic elastomer. An elastomer, for example a vulcanizate of natural rubber or silicone rubber, in particular of acrylonitrile butadiene rubber, can advantageously provide the necessary elasticity of the bypass wall. A thermoplastic elastomer has the additional advantage that it can be plastically deformed when heated to create a structuring of a surface of the bypass wall. In particular, the bypass wall having the structuring can be manufactured from a thermoplastic elastomer using an additive method, for example by 3D printing. A urethane-based thermoplastic elastomer and a vulcanizate of acrylonitrile butadiene rubber offer the advantage of high chemical resistance. The bypass wall, for example, has a Shore A hardness of 95.

The damper preferably comprises at least one bottom valve for regulating a flow of the damping fluid between the front chamber and the bypass, wherein the bottom valve causes a flow resistance of the flow that is dependent on a direction of flow and/or a flow velocity of the flow.

The bottom valve is designed, for example, in such a way that it causes a low flow resistance for a flow from the bypass into the front chamber and for a flow from the front chamber into the bypass at a flow velocity less than a switching velocity, and causes a high flow resistance, in particular blocks the flow, for a flow from the front chamber into the bypass at a flow velocity greater than or equal to the switching velocity. As a result, the damper dampens a slow insertion movement of the piston rod into the pressure tube and an extension movement of the piston rod out of the pressure tube with a low damping force and a fast insertion movement of the piston rod into the pressure tube with a high damping force. Such a velocity-dependent and direction-dependent damping force is particularly advantageous for damping the movement of a speed bump as in US 2019/106849 A1 or DE 10 2020 109 215 A1.

The damper preferably comprises at least one overload channel through the piston, which overload channel connects the front chamber to the rear chamber in a manner that conducts the damping fluid, and an overload valve that closes the overload channel when a differential pressure between the front chamber and the rear chamber is less than an overload pressure, and opens the overload channel when the differential pressure is greater than or equal to the overload pressure.

During a rapid movement of the piston in the pressure tube, for example due to a rapid insertion of the piston rod into the pressure tube, the bottom valve preferably causes a high flow resistance to the flow of the damping fluid into the bypass or blocks it completely, so that the piston is braked or stopped. If a large force is introduced into the damper via the piston rod in this state, the force causes a high differential pressure, which allows air from outside to flow into the pressure tube on the low-pressure side of the piston. In addition, the force can damage the damper or associated components in the blocked piston state. The overload channel having an overload valve allows an exchange of damping fluid between the front chamber and the rear chamber at a differential pressure above the overload pressure, allowing the piston to move and reducing the differential pressure, so that the damper and associated components are not damaged.

The damper preferably comprises a spring element, for example a coil spring, wherein the spring element is connected to the piston and/or to the piston rod and to the pressure tube to assist in extending the piston rod out of the pressure tube. If the damper does not have such a spring element, the extension of the piston rod can be achieved solely by the elastic restoring force of the bypass wall, which pushes the damping fluid from the bypass back into the pressure tube, so that the piston rod is extended out of the pressure tube. If the restoring force of the bypass wall is not sufficient for extension, for example because the piston rod is carrying a heavy speed bump, the spring element can ensure extension.

The method for producing the damper comprises providing a pressure tube for accommodating a damping fluid. The possible embodiments and advantages described for the damper also apply to the method.

The method comprises fastening a piston rod to a piston.

The method comprises arranging the piston in the pressure tube such that the piston is displaceably mounted along a stroke axis and divides the pressure tube into a front chamber along the stroke axis in front of the piston and a rear chamber along the stroke axis behind the piston, wherein the piston rod is led out of the pressure tube through the rear chamber along the stroke axis.

The method comprises arranging a bypass outside the pressure tube such that the bypass connects the front chamber to the rear chamber in a manner that conducts the damping fluid, wherein the bypass is delimited at least in portions by a bypass wall that is elastically deformable into the bypass (140) to accommodate a volume of the damping fluid displaced by the piston rod when the piston rod is inserted into the pressure tube.

### BRIEF DESCRIPTION OF THE DRAWINGS

Further advantages, objectives and properties of the invention are explained with reference to the following description and the accompanying drawings, in which exemplary subject matters according to the invention are shown.

FIG. 1 schematically shows an embodiment of the damper according to the invention with the piston rod partially inserted.

FIG. 2 schematically shows the embodiment of the damper from FIG. 1 with the piston rod extended.

FIGS. 3A and 3B show an example of a bypass wall of a damper according to the invention.

FIGS. 4A and 4B show an example of a sleeve of a damper according to the invention.

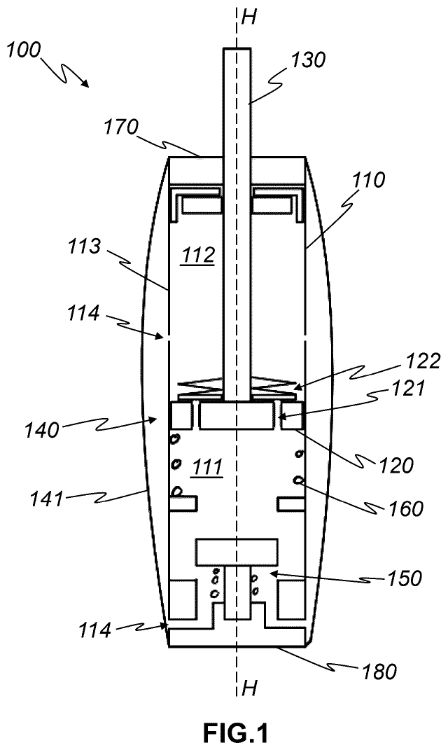

### FIG. 1

FIG. 1 schematically shows an embodiment of the damper 100 according to the invention with the piston rod 130 partially inserted into the pressure tube 110 of the damper 100 as a schematic longitudinal section along the stroke axis H of the damper 100.

The damper 100 shown comprises a pressure tube 110 filled with a damping fluid (not shown) and a piston 120 displaceably mounted in the pressure tube 110 along a stroke axis H, wherein the piston 120 divides the pressure tube 110 into a front chamber 111 along the stroke axis H in front of the piston 120 and a rear chamber 112 along the stroke axis H behind the piston 120.

The damper 100 shown comprises a piston rod 130 fastened to the piston 120, wherein the piston rod 130 is led out of the pressure tube 110 through the rear chamber 112 and through a guide and seal unit 170 along the stroke axis H. The guide and seal unit 170 closes one end of the pressure tube 110 to form a fluid-tight seal against the damping fluid. At the end of the pressure tube 110 opposite the guide and seal unit 170 along the stroke axis H, the pressure tube 110 is closed with a closure element 180 to form a fluid-tight seal against the damping fluid.

The damper 100 shown comprises a bypass 140 arranged outside the pressure tube 110, wherein the bypass 140 connects the front chamber 111 to the rear chamber 112 in a manner that conducts the damping fluid. For this purpose, the damper 100 comprises a number of openings 114 through a jacket wall 113 of the pressure tube 110 for the connection of the front chamber 111 and the rear chamber 112 to the bypass 140 in a manner that conducts the damping fluid.

The bypass 140 is delimited in portions by a bypass wall 141. In the state of the damper 100 shown in FIG. 1, the bypass wall 141 is elastically deformed into the bypass 140 radially outward from the stroke axis H by accommodating a volume of the damping fluid displaced by the piston rod 130 when the piston rod 130 is inserted into the pressure tube 110.

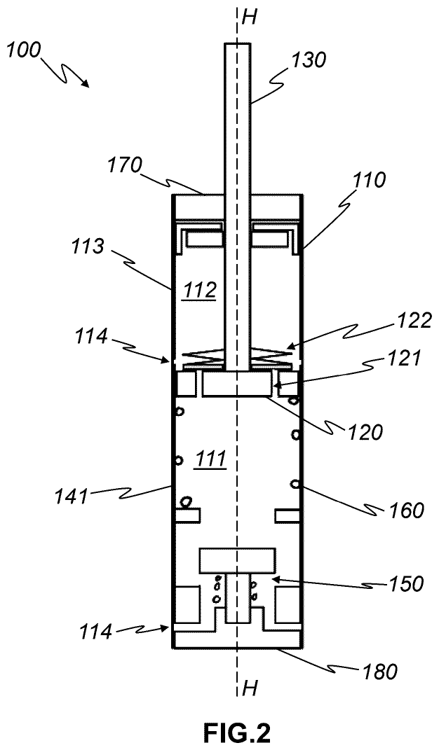

The bypass wall 141 is formed by a hose, wherein the pressure tube 110 is arranged in the hose such that the bypass 141 runs between the jacket wall 113 and the hose. The bypass wall 141 can be placed directly or indirectly against the jacket wall 113 over almost its entire length (see FIG. 2) and forms an outer wall of the damper 100.

At the ends of the pressure tube 110 along the stroke axis, the bypass wall 141 formed by the hose is fastened to the jacket wall 113 to form a fluid-tight seal against the damping fluid, so that the damping fluid cannot escape from the bypass 140 into the environment of the damper 100.

The damper 100 shown comprises a bottom valve 150 for regulating a flow of the damping fluid between the front chamber 111 and the bypass 140, wherein the bottom valve 150 causes a flow resistance of the flow that is dependent on a direction of flow and a flow velocity of the flow.

The damper 100 shown comprises at least one overload channel 121 through the piston 120, which overload channel connects the front chamber 111 to the rear chamber 112 in a manner that conducts the damping fluid, and an overload valve 122 that closes the overload channel 121 when a differential pressure between the front chamber 111 and the rear chamber 112 is less than an overload pressure, and opens the overload channel 121 when the differential pressure is greater than or equal to the overload pressure.

The damper 100 shown comprises a spring element 160, for example a coil spring, wherein the spring element 160 is connected to the piston 120 and to the pressure tube 110 to assist in extending the piston rod 130 out of the pressure tube 110.

### FIG. 2

FIG. 2 schematically shows the embodiment of the damper 100 from FIG. 1 with the piston rod 130 extended out of the pressure tube 110 as a schematic longitudinal section along the stroke axis H of the damper 100.

Since the piston rod 130 is extended out of the pressure tube 110, the volume of the damping fluid that was in the bypass 140 in the state of the damper 100 shown in FIG. 1 is in the pressure cylinder 110 in the state of the damper 100 shown in FIG. 2. As a result, the bypass wall 141 has elastically returned radially toward the stroke axis H, so that the bypass wall 141 rests against the jacket wall 113 of the pressure cylinder 110.

In order for the damping fluid to still be able to flow through the openings 114 in the jacket wall 113 and through the bypass (not visible) from the front chamber 111 into the rear chamber 112 and back, a surface of the bypass wall 141, which surface faces the jacket wall 113, has, for example, a structure (not shown) as a spacing means or a spacer through which the damping fluid can flow between the jacket wall 113 and the bypass wall 141.

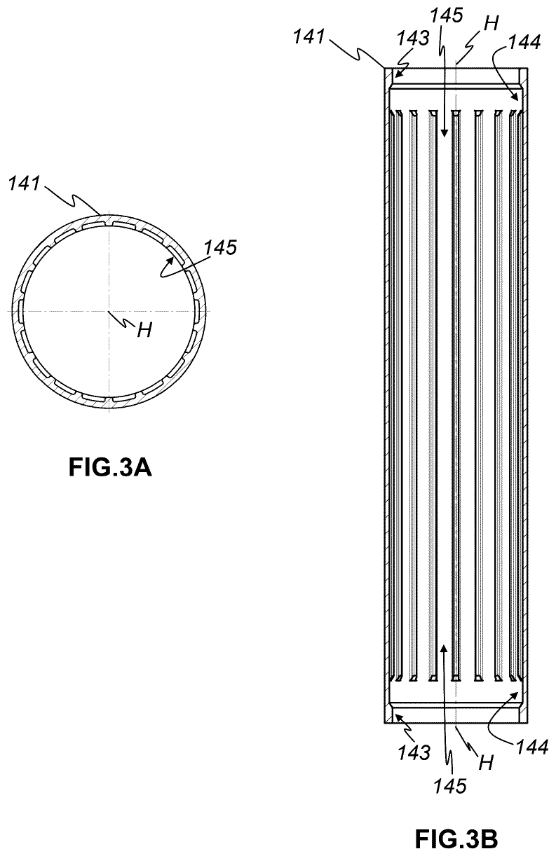

### FIGS. 3A AND 3B

FIGS. 3A and 3B show, by way of example, a bypass wall 141 of a damper 100 according to the invention as a cross section transverse to the stroke axis H of the damper 100 (FIG. 3A) and as a longitudinal section along the stroke axis H (FIG. 3B). The bypass wall 141 is designed, for example, as a hose, in particular made of an elastomer, and/or is hollow-cylindrical in shape and/or is arranged coaxially with the stroke axis H. Other components of the damper 100 are not shown in FIGS. 3A and 3B for the sake of clarity.

The bypass wall 141 shown comprises a structuring of a surface facing the jacket wall 113 of the pressure tube 110 (not shown) of the damper 100, in particular an inner surface, of the bypass wall 141 for spacing the bypass wall 141 from the jacket wall 113.

The structuring of the surface of the bypass wall 141 facing the jacket wall 113 comprises a number of grooves for the connection of the front chamber 111 of the pressure tube 110 of the damper 100 to the rear chamber 112 of the pressure tube 110 in a manner that conducts the damping fluid, wherein the structuring pressure tube 110, wherein the structuring serves as a spacing means or a spacer for spacing the bypass wall 141 from the jacket wall 113.

The number of grooves of the bypass wall 141 comprises a number of circumferential grooves 144 running about the stroke axis H, wherein the circumferential grooves 144 are preferably conductively connected to openings through the jacket wall 113 for the connection of the front chamber 111 and/or the rear chamber 112 to the bypass in a manner that conducts the damping fluid. For example, the bypass wall 141 has a first circumferential groove 144 near a first end of the bypass wall 141 that is connected to the front chamber 111 via openings through the jacket wall 113, and a second circumferential groove 144 near a second end of the bypass wall 141 that is connected to the rear chamber 112 via openings through the jacket wall 113.

The number of grooves comprises a number, in particular a plurality, of axial grooves 145 running along the stroke axis H, which are connected to the circumferential grooves 144 in a manner that conducts the damping fluid.

The bypass wall 141 comprises at least one sealing surface 143, in particular a sealing surface 143 at each of its ends. The sealing surface 143 is fastened to the jacket wall 113 to form a fluid-tight seal against the damping fluid and has no structuring.

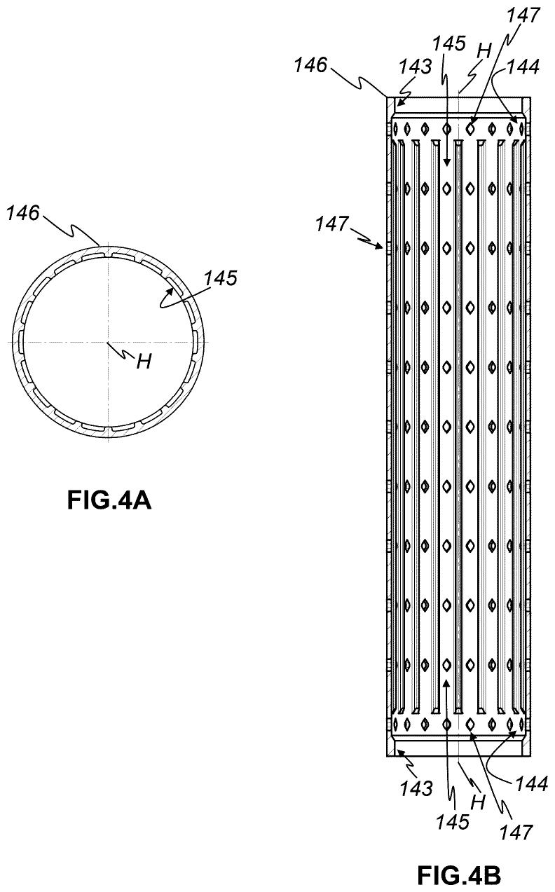

### FIGS. 4A AND 4B

FIGS. 4A and 4B show, by way of example, a sleeve 146 of a damper 100 according to the invention as a cross section transverse to the stroke axis H of the damper 100 (FIG. 4A) and as a longitudinal section along the stroke axis H (FIG. 4B). The sleeve 146 is preferably hollow-cylindrical in shape and/or arranged coaxially with the stroke axis H. Other components of the damper 100 are not shown in FIGS. 4A and 4B for the sake of clarity.

The sleeve 146 comprises a number of channels, for example a number of grooves, in particular in an inner surface of the sleeve 146, for the connection of the front chamber 111 of the pressure tube 110 of the damper 100 to the rear chamber 112 of the pressure tube 110 in a manner that conducts the damping fluid.

The sleeve 146 serving as a spacing means or as a spacer between the bypass wall 141 and the jacket wall 113 has a number of breaches 147, in particular a plurality thereof, for the passage of the damping fluid through the sleeve 146.

The number of grooves of the sleeve 146 comprises a number of circumferential grooves 144 running about the stroke axis H, wherein the circumferential grooves 144 are preferably conductively connected to openings through the jacket wall 113 of the pressure tube 110 of the damper 100 for the connection of the front chamber 111 and/or the rear chamber 112 to the bypass in a manner that conducts the damping fluid. For example, the sleeve 146 has a first circumferential groove 144 near a first end of the sleeve 146 that is connected to the front chamber 111 via openings through the jacket wall 113, and a second circumferential groove 144 near a second end of the sleeve 146 that is connected to the rear chamber 112 via openings through the jacket wall 113.

The number of grooves comprises a number, in particular a plurality, of axial grooves 145 running along the stroke axis H, which are connected to the circumferential grooves 144 in a manner that conducts the damping fluid.

The sleeve 146 comprises at least one sealing surface 143, in particular a sealing surface 143 at each of its ends. The sealing surface 143 is fastened to the jacket wall 113 to form a fluid-tight seal against the damping fluid and has no channels or breaches.

One embodiment (not shown) provides for the above-described openings 114 not to be arranged the jacket wall 113, but instead in a connecting component (not shown), by means of which the bypass wall 141 and/or the sleeve 146 are sealingly connected to the pressure tube 110.

Alternatively, it is also conceivable to integrate the openings in the guide and seal unit 170 or in the closure element 180. It must be ensured that the sealing fastening of the bypass wall 114 is designed accordingly.

A further alternative embodiment of the invention provides that the bypass wall or the above-described sleeve assumes the function of a closure element for the pressure tube 110. For this purpose, one end face of the bypass wall or sleeve is cup-shaped and sealingly closes the pressure tube 110. In this case, a separate closure element 180 can be omitted.

Accordingly, openings for the fluid-conducting connection between the front chamber and the bypass 140 can be arranged in the cup-shaped region of the bypass wall or the sleeve.

1. A damper comprising:
a pressure tube filled with a damping fluid;
a piston displaceably mounted in the pressure tube along a stroke axis (H), wherein the piston divides the pressure tube into a front chamber along the stroke axis (H) in front of the piston and a rear chamber along the stroke axis (H) behind the piston;
a piston rod fastened to the piston, wherein the piston rod is led out of the pressure tube through the rear chamber along the stroke axis (H); and
a bypass arranged outside the pressure tube, wherein the bypass connects the front chamber to the rear chamber in a manner that conducts the damping fluid;
wherein the bypass is delimited at least in portions by a jacket wall of the pressure tube that runs about the stroke axis (H) and at least in portions by a bypass wall,
wherein the bypass wall is elastically deformable into the bypass to accommodate a volume of the damping fluid displaced by the piston rod when the piston rod is inserted into the pressure tube.

2. The damper according to claim 1,
wherein the bypass wall is formed by a hose.

3. The damper according to claim 2,
wherein the pressure tube is arranged in the hose so that the bypass runs between the jacket wall and the hose.

4. The damper according to claim 2,
wherein the damper comprises spacing means for spacing the bypass wall from the jacket wall.

5. The damper according to claim 4,
wherein the spacing means comprise a sleeve arranged between the bypass wall and the jacket wall and having a number of channels for the connection of the front chamber to the rear chamber in a manner that conducts the damping fluid, wherein the sleeve has a number of breaches for the passage of the damping fluid through the sleeve.

6. The damper according to claim 4,
wherein the spacing means comprise a structuring of a surface of the bypass wall, which surface faces the jacket wall, for spacing the bypass wall from the jacket wall.

7. The damper according to claim 6,
wherein the structuring of the surface of the bypass wall, which surface faces the jacket wall, comprises a number of knobs and/or a number of grooves for the connection of the front chamber to the rear chamber in a manner that conducts the damping fluid.

8. The damper according to claim 7,
wherein the number of grooves of the bypass wall and/or of the sleeve comprises a number of circumferential grooves running about the stroke axis (H), and wherein the number of grooves comprises a number of axial grooves running along the stroke axis (H), which axial grooves are connected to the circumferential grooves in a manner that conducts the damping fluid.

9. The damper according to claim 1,
wherein the damper comprises a number of openings for the connection of the front chamber and the rear chamber to the bypass in a manner that conducts the damping fluid.

10. The damper according to claim 9,
wherein the openings are formed in the jacket wall.

11. The damper according to claim 9,
wherein the openings are connected to the circumferential grooves in a manner that conducts the damping fluid.

12. The damper according to claim 1,
wherein the bypass wall comprises a sealing surface,
wherein the sealing surface for the damping fluid is sealingly attached to the jacket wall; and
wherein the sealing surface has no structuring, channels or breaches.

13. The damper according to claim 5,
wherein the bypass wall and/or the sleeve comprises a sealing surface,
wherein the sealing surface for the damping fluid is sealingly attached to the jacket wall; and
wherein the sealing surface has no structuring, channels or breaches.

14. The damper according to claim 1,
wherein the bypass wall is made of an elastomer.

15. The damper according to claim 1,
wherein the damper comprises a bottom valve for regulating a flow of the damping fluid between the front chamber and the bypass, wherein the bottom valve causes a flow resistance of the flow that is dependent on a direction of flow and/or on a flow velocity of the flow.

16. The damper according to claim 1,
wherein the damper comprises:
an overload channel through the piston that connects the front chamber to the rear chamber in a manner that conducts the damping fluid; and
an overload valve that closes the overload channel when a differential pressure between the front chamber and the rear chamber is less than an overload pressure, and opens the overload channel when the differential pressure is greater than or equal to the overload pressure.

17. The damper according to claim 1,
wherein the damper comprises a spring element, wherein the spring element is connected to the piston and/or to the piston rod and to the pressure tube to assist in extending the piston rod out of the pressure tube.

18. A method for producing a damper according to claim 1, comprising the following steps:
a. providing a pressure tube (110) for accommodating a damping fluid;
b. fastening a piston rod to a piston;
c. arranging the piston in the pressure tube such that the piston is displaceably mounted along a stroke axis (H) and divides the pressure tube into a front chamber along the stroke axis (H) in front of the piston and a rear chamber along the stroke axis (H) behind the piston, wherein the piston rod is led out of the pressure tube through the rear chamber along the stroke axis (H); and
d. arranging a bypass outside the pressure tube such that the bypass connects the front chamber to the rear chamber in a manner that conducts the damping fluid, wherein the bypass is delimited at least in portions by a bypass wall that is elastically deformable into the bypass to accommodate a volume of the damping fluid displaced by the piston rod when the piston rod is inserted into the pressure tube.
